(19) United States
(12) Patent Application Publication
(10) Pub. No.: US 2026/0140715 A1
(43) Pub. Date: May 21, 2026

(54) Method and Device for Code Generation for Creating a Program Code for Calculating an Artificial Neural Network in a Hardware Environment

(71) Applicant: Robert Bosch GmbH, Stuttgart (DE)

(72) Inventors: Duy Khoi Vo, Waiblingen (DE); Benjamin Wagner, Friedrichshafen (DE); Leif Sulaiman, Lund (SE); Markus Lochmann, Reutlingen (DE); Sebastian Boblest, Duernau (DE); Ulrik Hjort, Malmö (SE)

(21) Appl. No.: 19/387,998

(22) Filed: Nov. 13, 2025

(30) Foreign Application Priority Data
Nov. 15, 2024 (DE) 10 2024 211 010.8

(51) Int. Cl. G06F 8/35; G06F 8/36

(52) U.S. Cl. CPC G06F 8/35; G06F 8/36

(57) ABSTRACT

A computer-implemented method for performing a code generation for calculating a Softmax function of a neural network includes (i) providing a displacement s and a multiplier for the quantized representation of the input tensors of the Softmax function of the neural network, (ii) creating a second lookup table to replace a nested function to calculate the EXP_ON_NEG (MUL_SAT ( )) function from a CMSIS NN library depending on the displacement and the multiplier, wherein element values of an input tensor normalized to a negative value range between 0 and a minimum value are used as arguments, wherein 0 is assigned to a maximum possible element value of the input tensor and the minimum value is assigned to the smallest possible element value of the input tensor, and (iii) implementing an access to the second lookup table in a code generated to calculate the Softmax function, so that it replaces the function call of the EXP_ON_NEG (MUL_SAT ( )) function.

This application claims priority under 35 U.S.C. § 119 to application no. DE 10 2024 211 010.8, filed on Nov. 15, 2024 in Germany, the disclosure of which is incorporated herein by reference in its entirety.

The disclosure relates to the implementation of a program code on a hardware environment, such as that occurring as microcontroller-controlled control devices and the like. The disclosure further relates to methods for efficiently computing a Softmax function.

### BACKGROUND

Certain hardware environments, such as microcontrollers in control devices, require the creation of an adjusted executable program code to take into account the characteristics and limitations of the specific hardware environment. In particular, the available memory size of the memory that the microcontroller can directly access may be limited or the processor speed may be limited.

The calculation steps for calculating corresponding layers of neural networks require significant computational effort. Existing code generators determine which algorithms are used for calculating the individual layers during code generation. In particular, a trade-off between the required memory requirement in the memory and the computing speed can often be selected by the code generator.

Softmax is a common type of layer in neural networks. Softmax generates a probability distribution from any vector of input values and is therefore often used in CNN classification networks, but also in modern transformer networks.

The calculation of a Softmax layer is very computationally complex and therefore it is attempted to avoid the calculation of the Softmax layer if possible, such as the approach from Lu, Jiachen et al. shows. “SOFT: Softmax-free Transformer with Linear Complexity.” Neural Information Processing Systems (2021).

It is the object of the present disclosure to provide an improved method for accelerating the Softmax calculation in quantized models for use in a code generator.

### SUMMARY

This task is solved by the method for performing a code generation for creating a code for calculating a neural network according to the description below as well as by the device according to the description below.

Further embodiments are also specified in the description below.

According to a first aspect, a computer-implemented method for performing a code generation for calculating a Softmax function of a neural network is provided, with the steps of.
providing a displacement s and a multiplier m for the quantized representation of the input tensors of the calculation steps of the neural network;
creating a second lookup table to replace a nested function to compute the EXP_ON_NEG (MUL_SAT ( )) function from a CMSIS NN library depending on the displacement s and the multiplier m, wherein element values of an input tensor normalized to a negative value range between 0 and a minimum value are used as arguments, wherein 0 is assigned to a maximum possible element value of the input tensor and the minimum value is assigned to the smallest possible element value of the input tensor;
implementing an access to the lookup table in a code generated to calculate the Softmax function, so that it replaces the function call of the EXP_ON_NEG (MUL_SAT ( )) function.

Calculating a Softmax layer in neural networks is very complex. For float networks, the Softmax function is used as the

$${softmax ( x )}_{i} = \frac{{e}^{{x}_{i}}}{{\sum }_{j} {e}^{{x}_{j}}}$$

In the first step, the element values xi of an input tensor are normalized by the maximum value of max({xⱼ}) the input tensor x before the Softmax calculation, as follows

$${d}_{i} = {x}_{i} - max ( \{ {x}_{j} \} )$$

so that all element values in the input tensor d are 0 or less, and the Softmax function is then

$${softmax ( x )}_{i} = \frac{{e}^{{d}_{i}}}{{\sum }_{j} {e}^{{d}_{j}}}$$

For quantized networks, the relationship

$${x}_{i} \frac{{x}_{i}^{q} \times {2}^{\text{?}} \times m}{{2}^{31}} ,$$

$$\text{?} \text{indicates text missing or illegible when filed}$$

between the float value xi and the quantized value

$${x}_{i}^{q}$$

and analogously

$${d}_{i} \underline{\approx } \frac{{x}_{i}^{q} \times {2}^{s} \times m}{{2}^{31}} ,$$

with the displacement s and multiplier m.

The above method provides a method for code generation for a code for implementing a quantized Softmax function using one or more lookup tables that improves the computational time by an order of magnitude.

FIGS. 1a-1d shows a Softmax implementation in CMSIS-NN as the prior art, see Liangzhen Lai and Naveen Suda and Vikas Chandra (2018), “CMSIS-NN: Efficient Neural Network Kernels for Arm Cortex-M CPUs”, ArXiv

In the normalized version of Softmax, all exponents are 0 or negative. CMSIS-NN implements the function EXP_ON_NEG (see FIG. 1b) to calculate the exponentially negative arguments and a saturated multiplication MUL_SAT (see Section 1c) to avoid numerical overflow, i.e. the function MUL_SAT ensures that the result of the multiplication of two int32 integers, which may otherwise also remain outside the range of int32 numbers, is always limited to the int32 value range.

With these two functions, the CMSIS-NN uses the relationship

$$E ( {d}_{j}^{q} , s , m ) = {e}^{{d}_{j}^{q} \times {2}^{s} \times m} = EXP\_ON \_NEG ( MUL\_SAT ( {d}_{j}^{q} \times {2}^{s} , m ) ) .$$

The sum in the denominator of the above calculation formula for Softmax Σje^{dj} could still result in a numeric overflow. For this reason, CMSIS-NN scales by a factor of 2^{ACCUM_BITS} during summation with the DIV_POW2 function, so that

$${\sum }_{j} {e}_{scales}^{{d}_{j}} = {\sum }_{j} DIV\_POW 2 ( E ( {d}_{j}^{q} , s , m ) , {2}^{ACCUM \_ BITS} ) mit {ACCUM}_{BITS} = 12$$

as shown in line 23 of the code of FIG. 1a.

The next step in CMSIS-NN is to evaluate the denominator's reversal Σje^{dj} as

$$shifted\_scaled = ONE\_OVER1 ( ( sum > 0 ? sum ≪ headroom : 0 ) - ( 1 ≪ 31 )$$

wherein

$$headroom = C L Z ( {\sum }_{j} {e}^{{d}_{j}} )$$

(see lines 26-28 in the code of FIG. 1a).
where:

$$bits\_over \_unit = ACCUM\_BITS - headroom + 23 ,$$

(see line 30 in the code of FIG. 1a), the result is then

$$softmax ( {d}_{j}^{q} ) = DIV\_POW 2 ( MUL\_SAT ( shifted\_scaled , E ( {d}_{j}^{q} , s , m ) ) , bits\_over \_unit ) ,$$

(see lines 34-37 of the code of FIG. 1a). Finally, the result must be brought into an 8-bit range (see lines 38-41 in the code of FIG. 1a).

For reference, the sub-functions EXP_ON_NEG in FIG. 1b, MUL_SAT in FIG. 1c and DIV_POW2 in FIG. 1d are shown.

The above method utilizes replacing at least one of the calculations of the conventional Softmax function with a lookup table for implementing the Softmax function in the code generator.

The size

$$E ( {d}_{j}^{q} , s , m )$$

in the above equation will depend on

$${d}_{j}^{q} ,$$

the displacement (shift, mask), and the multiplier m (mult). The displacement s and multiplier m are constant and known at the time of code generation, so that for each Softmax function in the network only

$${d}_{j}^{q}$$

is a variable. In this way, a lookup table can be created that contains all possible values of

$$E ( {d}_{j}^{q} , s , m )$$

depending on

$${d}_{j}^{q}$$

and that the second lookup table is in the above approach:

$$LUT 2 [ {d}_{j}^{q} ] = E ( {d}_{j}^{p} , s , m ) = EXP\_ON \_NEG ( MUL\_SAT ( {ϵ}^{{d}_{j}^{q} \times {2}^{s}} , m ) ) .$$

This lookup table LUT2 contains 32 Bit values.

The method comprises the following further steps:
creating a first lookup table to replace a nested function DIV_POW2(EXP_ON_NEG(MUL_SAT ( ))) from a CMSIS NN library depending on the displacement s and the multiplier m, wherein element values of an input tensor normalized to a negative value range between 0 and a minimum value are used as arguments, wherein 0 is assigned to a maximum possible element value of the input tensor and the minimum value is assigned to the smallest possible element value of the input tensor;
implementing an access to the first lookup table in a code generated to compute the Softmax function, so that it corresponds with the function call of the DIV_POW2(EXP_ON_NEG(MUL_SAT ( ))) function.

In the calculation

$$E ( {d}_{j}^{q} , s , m ) ,$$

not every summand is constant in sum. Thus, a first lookup table for the entire calculation of each summand in the above-mentioned can be Relation

$${\sum }_{j} {e}_{scaled}^{{d}_{j}^{q}} = {\sum }_{j} DIV\_POW2 ( E ( {d}_{j}^{q} , s , m ) , {2}^{ACCUM \_ BITS} )$$

created, that is denoted as

$$LUT 1 [ {d}_{j}^{q} ] = {e}_{scaled}^{{d}_{j}^{q}} = DIV\_POW2 ( EXP\_ON \_NEG ( MUL\_SAT ( {d}_{j}^{q} \times {2}^{s} , m ) ) , {2}^{ACCUM \_ BITS} ) ,$$

and again contains 32-Bit values.

The two lookup tables replace the much slower calculations in the standard implementation of FIGS. 1a-1d.

The need for two lookup tables arises because the above Relation

$$soft max ( {d}_{j}^{q} ) = DIV\_POW2 ( MUL\_SAT ( shifted\_scaled , E ( {d}_{j}^{q} , s , m ) ) , bits\_over \_unit ) ,$$

depends on shifted_scaled

$${e}_{scaled}^{{d}_{j}^{q}}$$

and bits_over_unit formed from all input data together. For this reason, this expression cannot be expressed entirely with a lookup table. The method replaces the calculation with lookup tables where possible.

The two lookup tables are different for each combination of displacement s and multiplier m resulting from the quantization parameters of the respective Softmax layer in the given model. The quantization parameters are a result of quantization with another software tool independent of the method, e.g. the tensorflow lite model converter. For this reason, this technique may not be used in a library implementation of a Softmax function, but only in a code generator that can generate the lookup tables during code generation for each specific Softmax function.

The value diff calculated in lines 21 and 32 in both Softmax versions is equal to zero for the largest element value in the input tensor and negative for all other values with diff [symbol] [−255, 0].

The smallest element values input[col] in the input tensor give the largest negative values of diff. It is possible that the smallest negative values of diff are so small that they cannot be calculated in the quantized representation and are therefore ignored. Both the CMSIS NN version and the LUT-based version of Softmax use the diff_min variable to set a corresponding threshold value. It corresponds to a negative value calculated from the quantization properties of the respective Softmax layer in the network.

Since the above equations are only evaluated if diff>=diff_min, both lookup tables may only contain values for diff∈[diff_min, 0], i.e. both lookup tables have a maximum size of 256 entries, which corresponds to 1 kB of memory required each. However, if diff_min is >−255, then the lookup tables will be smaller than 256 entries. In addition, the calculation formula of the first lookup table may return 0 for the smallest values of

$${d}_{j}^{q} ,$$

that is, the first entries in the lookup table. These values are then removed from the lookup table and the number of removed zeros are stored in a table value LUT1_offset which is an additional function argument for the new function.

With these optimizations, the lookup tables generated are always as small as possible and the amount of storage space needed is minimized.

According to another aspect, there is provided a method for calculating a Softmax function with a code generated using any of the above methods.

According to a further aspect, provided is a device for performing the above method.

### BRIEF DESCRIPTION OF THE DRAWINGS

Preferred embodiments are described in more detail below with reference to the accompanying drawings. The figures show:

FIGS. 1a-1d a code for a conventional CMSIS-NN algorithm for calculating a Softmax function;

FIG. 2 a schematic illustration of a platform for code generation and implementation in a hardware environment;

FIG. 3 a flow chart illustrating the method steps for code generation for a Softmax function;

FIG. 4 a code for a CMSIS-NN algorithm adapted by the code generator for calculating a Softmax function.

### DETAILED DESCRIPTION

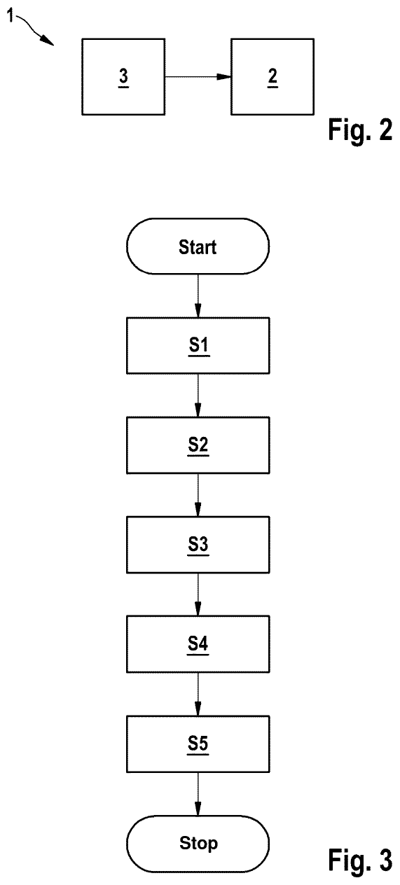

FIG. 2 shows a block diagram of a platform 1 for performing code generation and implementing a generated program code in a hardware environment 2. For example, the hardware environment corresponds to a control device having a microcontroller, microprocessor, or the like. Code generation is done on a conventional computer 3 or workstation based on the specified configuration of a neural network. Computer 3 is configured to perform memory planning and code generation for a specified sequence of calculation steps, wherein memory planning initially performs a placement of memory areas for the individual calculation steps of the neural network for including at least one input data block and at least one output data block. The code generation provides for the generation of the code for the executions of the calculations of the individual calculation steps.

Once the code has been generated, it is transferred to the hardware environment 2, where it is implemented or executed.

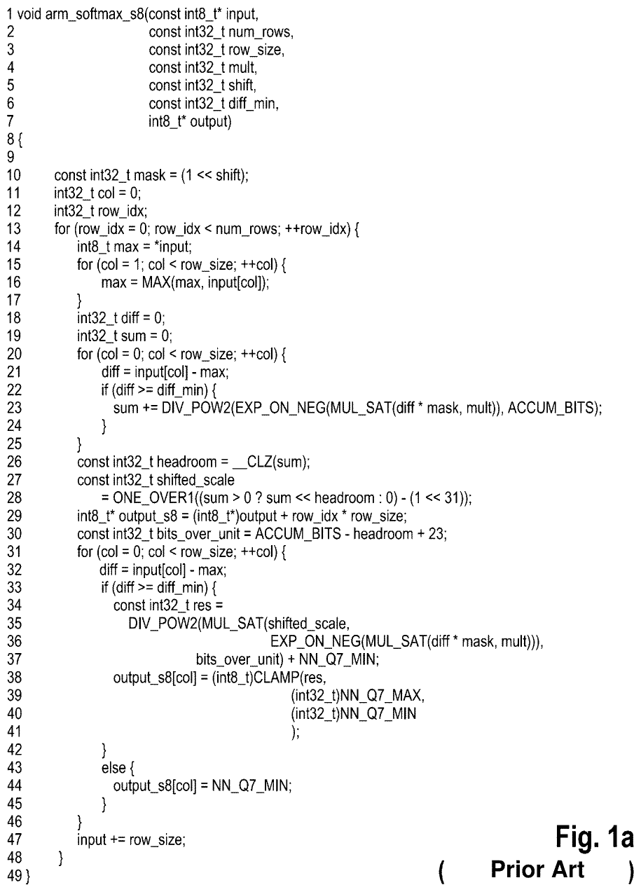

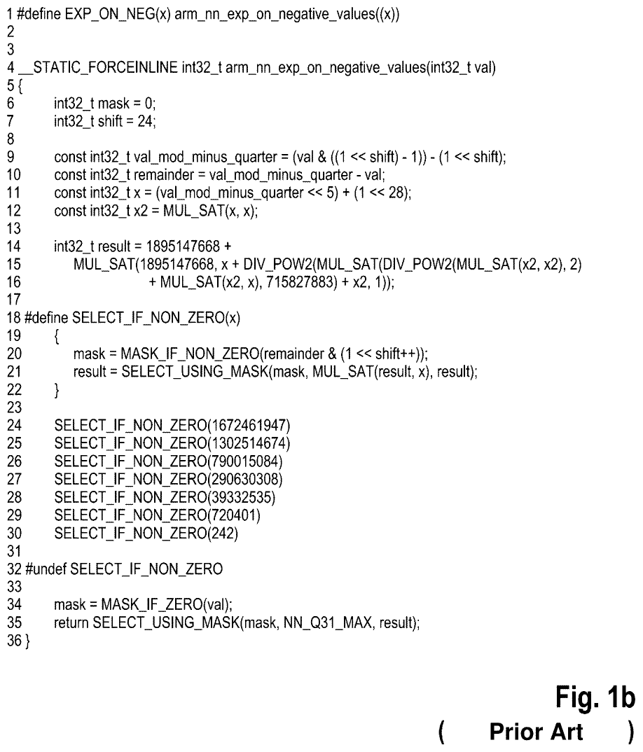

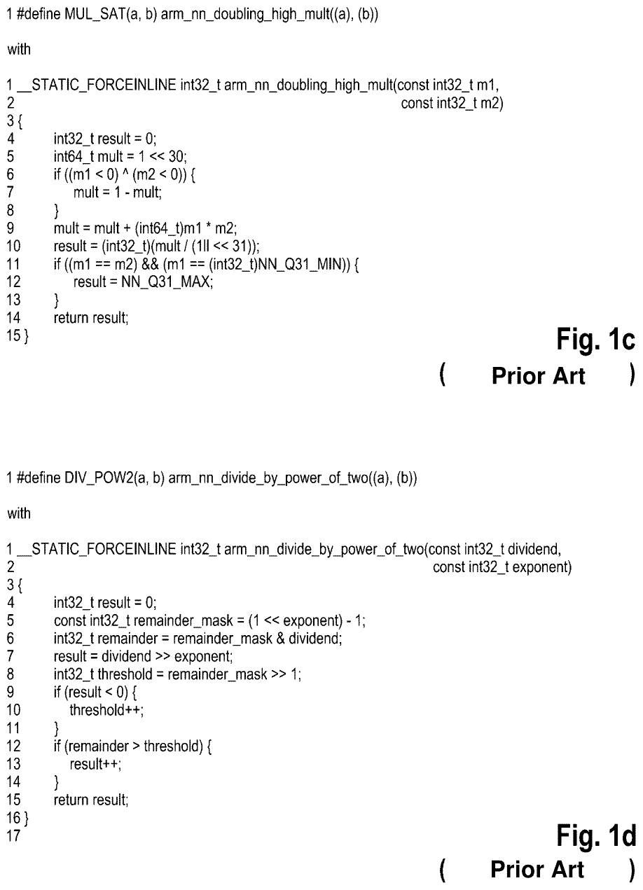

In conjunction with the flowchart of FIG. 3, a method is described for generating code for calculating a Softmax function, in which one or two functions from the Softmax function shown in FIGS. 1a-1d are replaced by a first look-up table LUT1 and a second look-up table LUT2.

In step S1, a displacement s and a multiplier m for the 8-Bit representation of the input sensors of the calculation steps of the neural network are determined.

The values for s and m are calculated in a manner known by itself from the quantization parameters of the respective Softmax layer, i.e., in particular, the scaling of the input tensor, as well as the selectable beta parameter of Softmax layers. This is done analogously to the calculation in other deployment solutions, such as tensorflow lite micro. This is done separately for each layer of the neural network, both Softmax and all others. The calculation specification can be implemented analogously to, e.g. Tensorflow lite micro.

In step S2, a lookup table LUT2 is created for the calculation specification of lines 34-37,

$$const int32\_t res = DIV\_POW2 ( MUL\_SAT ( shifted\_ scale , EXP\_ON \_NEG ( MUL\_SAT ( diff * mask , mult ) ) ) , bits\_ over\_unit ) + NN\_Q7 \_MIN ;$$

in particular, the EXP_ON_NEG algorithm of the conventional algorithm of FIG. 1a.

The magnitude

$$E ( {d}_{j}^{q} , s , m )$$

in the above equation

$$LUT 2 [ {d}_{j}^{q} ] = E ( {d}_{j}^{q} , s , m ) = EXP\_ON \_NEG ( MUL\_SAT ( {e}^{{d}_{j}^{q} \times {2}^{s}} , m ) ) .$$

depends on

$${d}_{j}^{q} ,$$

the shift s, and the multiplier m.

The displacement s and the multiplier m are initially determinable and constant based on the quantization parameters of the Softmax layer in the model, so that only

$${d}_{i}^{q}$$

is a variable for each Softmax function in the network. In this way, a lookup table can be created that contains all possible values of

$$E ( {d}_{j}^{q} , s , m )$$

depending on

$${d}_{i}^{q} .$$

As the values

$${x}_{i}^{q}$$

of the quantized input value are in int8 format, with a value range

$${x}_{i}^{q} ∈ [ - 128 , 127 ] ,$$

and the values

$${d}_{i}^{q}$$

result from subtracting the maximum value from

$${x}_{i}^{q} ,$$

the

$${d}_{i}^{q}$$

can assume a maximum value of

$${d}_{i}^{q} ∈ [ - 255 , 0 ] .$$

The diff value calculated in lines 21 and 32 in both Softmax versions corresponds to this value of

$${d}_{i}^{q} .$$

Accordingly, diff is equal to zero for the largest element value in the input tensor and negative for all other values with

$$diff ∈ [ - 255 , 0 ] .$$

To create the table, the expression

$$E ( {d}_{j}^{q} , s , m )$$

for all these values of

$${d}_{i}^{q}$$

or diff are therefore evaluated for a given s and m.

This lookup table LUT2 contains 32-bit values.

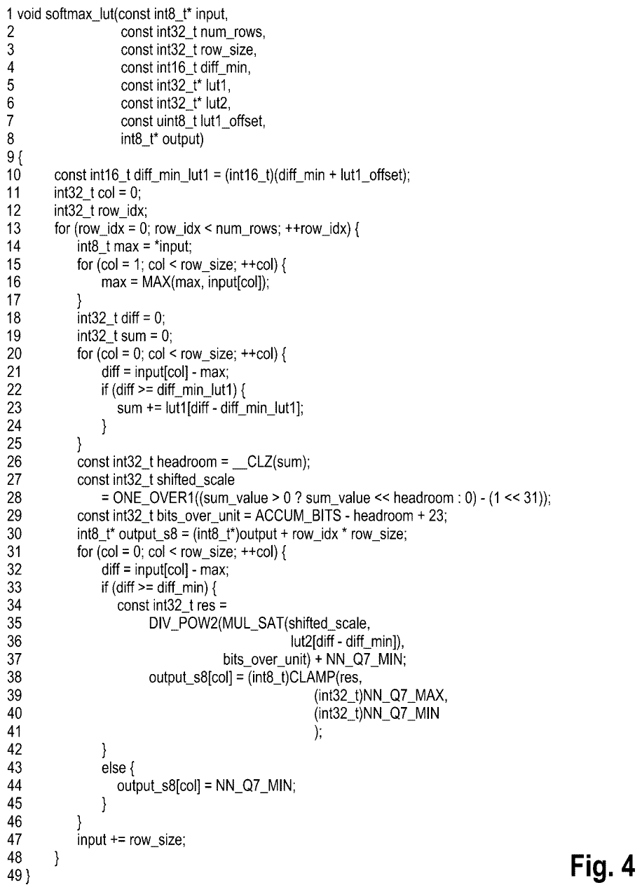

In step S3, the code generator implements access to the second lookup table LUT2 in the program code for calculating the EXP_ON_NEG algorithm of the Softmax function shown in FIG. 1b. This is shown in the code of FIG. 4 in lines 34-37.

In step S4, the first lookup table LUT1 is created, which is to replace the calculation rule

$$i . sum + - DIV\_POW2 ( EXP\_ON \_NEG ( MUL\_SAT ( diff * mask , mult ) ) , ACCUM\_BITS ) ;$$

of line 23.

In the calculation,

$$E ( {d}_{j}^{q} , s , m )$$

is constant for every summand in the sum. Thus, the first lookup table for the entire calculation of each summand in the above Relation

$${\sum }_{j} {e}_{scaled}^{{d}_{j}^{q}} = {\sum }_{j} DIV\_POW2 ( E ( {d}_{j}^{q} , s , m ) , {2}^{ACCUM \_ BITS} )$$

are created, that is denoted as

$$LUT 1 [ {d}_{j}^{q} ] = {e}_{scaled}^{{d}_{j}^{q}} = DIV\_POW2 ( EXP\_ON \_NEG ( MUL\_SAT ( {d}_{j}^{q} \times 2 \text{?} , m ) ) , {2}^{ACCUM \_ BITS} ) ,$$

$$\text{?} \text{indicates text missing or illegible when filed}$$

and again contains 32-bit values.

Analogously to the calculation of LUT2, for the LUT1 table, the relation

$$LUT 1 [ {d}_{j}^{q} ] = {e}_{scaled}^{{d}_{j}^{q}} = DIV\_POW2 ( EXP\_ON \_NEG ( MUL\_SAT ( {d}_{j}^{q} \times 2 \text{?} , m ) ) , {2}^{ACCUM \_ BITS} ) ,$$

$$\text{?} \text{indicates text missing or illegible when filed}$$

for all possible values of

$${d}_{i}^{q}$$

is evaluated.

The smallest element values input[col] in the input tensor give the largest negative values of diff. It is possible that the smallest negative values of diff are so small that they cannot be calculated in the quantized representation and are therefore ignored. Both the CMSIS NN version and the LUT-based version of Softmax use the diff_min variable to set a corresponding threshold value. It corresponds to a negative value that, analogously to the multiplier m and the displacement s, is calculated or predetermined from the quantization properties of the respective Softmax layer in the network.

Since the above equations are only evaluated if diff>=diff_min, both lookup tables may only contain values for diff [diff_min, 0], i.e. both lookup tables have a maximum size of 256 entries, which corresponds to 1 kB of memory required each. However, if diff_min is >−255, then the lookup tables will be smaller than 256 entries. In addition, the calculation formula of the first lookup table may return 0 for the smallest values of

$${d}_{j}^{q} ,$$

that is, the first entries in the lookup table. These values are then removed from the lookup table and the number of removed zeros are stored in an integer value LUT1_offset which is an additional function argument for the new function.

In step S5, the code generator implements access to the first lookup table LUT1 in the program code for computing the algorithm of nested functions

$$DIV\_POW2 ( EXP\_ON \_NEG ( MUL\_SAT ( {d}_{j}^{q} \times 2 \text{?} , m ) ) , {2}^{ACCUM \_ BITS} )$$

$$\text{?} \text{indicates text missing or illegible when filed}$$

of the Softmax function.

What is claimed is:

1. A computer-implemented method for performing a code generation for computing a Softmax function of a neural network, comprising:
providing a displacement and a multiplier for the quantized representation of the input tensors of the Softmax function of the neural network;
creating a second lookup table to replace a nested function to calculate the EXP_ON_NEG (MUL_SAT ( )) function from a CMSIS NN library depending on the displacement and the multiplier, wherein element values of an input tensor normalized to a negative value range between 0 and a minimum value are used as arguments, wherein 0 is assigned to a maximum possible element value of the input tensor and the minimum value is assigned to the smallest possible element value of the input tensor; and
implementing an access to the second lookup table in a code generated to calculate the Softmax function, so that it replaces the function call of the EXP_ON_NEG (MUL_SAT ( )) function.

2. The method according to claim 1, further comprising:
creating a first lookup table to replace a nested function DIV_POW2(EXP_ON_NEG(MUL_SAT ( ))) from a CMSIS NN library depending on the displacement and the multiplier, wherein element values of an input tensor normalized to a negative value range between 0 and a minimum value are used as arguments, wherein 0 is assigned to a maximum possible element value of the input tensor and the minimum value is assigned to the smallest possible element value of the input tensor; and
implementing an access to the first lookup table in a code generated to calculate the Softmax function, so that it replaces the function call of the DIV_POW2(EXP_ON_NEG(MUL_SAT ( ))) function.

3. A method for computing a Softmax function with a code generated by the method of claim 1.

4. A device for performing the method according to claim 1.

5. A computer program product comprising instructions which, when the program is executed by at least one data processing device, cause the data processing device to perform the steps of the method according to claim 1.

6. A machine-readable storage medium comprising commands which, when executed by at least one data processing device, cause the data processing device to perform the steps of the method according to claim 1.
